(19) United States
(12) Patent Application Publication
(10) Pub. No.: US 2013/0187504 A1
(43) Pub. Date: Jul. 25, 2013

(54) DYNAMO-ELECTRIC MACHINE

(71) Applicant: Daiki Tanaka, Zama-shi (JP)

(72) Inventor: Daiki Tanaka, Zama-shi (JP)

(73) Assignee: NISSAN MOTOR CO., LTD

(21) Appl. No.: 13/821,684

(22) PCT Filed: Sep. 27, 2011
(86) PCT No.: PCT/JP2011/005423

§ 371 Date: Mar. 8, 2013

(30) Foreign Application Priority Data
Sep. 29, 2010 (GB) 1016354.1
Apr. 14, 2011 (GB) 1106338.5
Apr. 18, 2011 (GB) 1106526.5
Apr. 19, 2011 (GB) 1106613.1
Apr. 21, 2011 (GB) 1106723.8

(51) Int. Cl. H02K 1/27

(52) U.S. Cl. CPC H02K 1/2706
USPC 310/156.01

(57) ABSTRACT

A dynamo-electric machine includes: a stator (5) having a plurality of stator coils (9); a rotor (1) surrounded by the stator (5), having a magnetically anisotropic rotor core (11), a plurality of permanent magnets (3) and at least one magnetically isotropic core element (24); a magnetic shunt (4) configured to shunt the magnetic flux of the at least one of the permanent magnets (3); and a shunt drive mechanism configured to locate the magnetic shunt (4) against the at least one magnetically isotropic core element (24).

### TECHNICAL FIELD

The disclosure discussed hereinafter relates to a dynamo-electric machine and in particular, but not exclusively, to a dynamo-electric machine comprising a brushless DC motor having a permanent magnet rotor mounted within an annular stator.

### BACKGROUND ART

Dynamo-electric machines of the type described above may be used either as motors or as generators. It should be understood that although such a machine may be referred to herein as a “motor”, this is not intended to preclude the possible use of the machine as a generator by driving it in reverse.

In dynamo-electric machines of the type described, the rotor carries a set of permanent magnets and the stator carries a set of stator coils. These stator coils are energised sequentially to produce a rotating magnetic field, which causes rotation of the permanent magnet rotor.

### CITATION LIST

### Patent Literature

[PTL 1] Japanese Patent Application Laid-Open No. JP2007-244023A

### SUMMARY OF INVENTION

### Technical Problem

When rotating, the permanent magnets of the rotor induce an electro-motive force (hereinafter abbreviated to “back EMF”), which induces a voltage in the stator coils which increases as the rotor speeds up. This induced voltage must be kept below the input voltage of the electrical supply, so as to avoid damage to the power supply devices, such as the inverter and battery. This control of induced voltage allows power to be fed into the motor to increase output. However, most of the current used to control induced voltage does not contribute directly to torque generation. It is therefore desirable to minimize current used for control purposes.

### Solution to Problem

In order to solve the above-mentioned problem, a dynamo-electric machine according to the embodiment includes: a stator having a plurality of stator coils; a rotor surrounded by the stator, having a magnetically anisotropic rotor core, a plurality of permanent magnets and at least one magnetically isotropic core element; a magnetic shunt configured to shunt the magnetic flux of the at least one of the permanent magnets; and a shunt drive mechanism configured to locate the magnetic shunt against the at least one magnetically isotropic core element.

### Advantageous Effect of Invention

According to the embodiment, The magnetically isotropic core element increases flux leakage through the magnetic shunt when the magnetic shunt is located against the at least one magnetically isotropic core element, thereby decreasing the back EMF, loss of power generated by the dynamo-electric machine, and load applied to devices which supply current to the dynamo-electric machine.

### BRIEF DESCRIPTION OF DRAWINGS

FIG. 1A is axial section showing a dynamo-electric machine according to a first embodiment, in a shunting position;

FIG. 1B is axial section showing a dynamo-electric machine according to a first embodiment, in a non-shunting position;

FIG. 2 is a schematic isometric view of a rotor of a dynamo-electric machine, illustrating the axial (A), radial (R), and tangential (T) directions thereof;

FIG. 3 is a radial cross-section showing schematically part of the rotor 1 and stator 5 of a dynamo-electric machine shown in FIGS. 1A and 1B;

FIG. 4 is a circular axial section of the dynamo-electric machine of FIG. 3 with a magnetic shunt 4 in a shunting position;

FIG. 5 is circular axial section through the dynamo-electric machine of FIG. 3 along line X of FIG. 10, showing computer-modelled illustrations of the magnetic flux lines 14 with the magnetic shunt 4 in non-shunting position;

FIG. 6 is circular axial section through the dynamo-electric machine of FIG. 3 along line X of FIG. 10, showing computer-modelled illustrations of the magnetic flux lines 14 with the magnetic shunt 4 in shunting position;

FIG. 7A is axial section showing a dynamo-electric machine according to a second embodiment, in a shunting position;

FIG. 7B is axial section showing a dynamo-electric machine according to a second embodiment, in a non-shunting position;

FIG. 8 is a radial cross-section showing part of the rotor 1 and stator 5 of a dynamo-electric machine shown in FIGS. 7A and 7B;

FIG. 9 is a circular axial section through the dynamo-electric machine of FIG. 8, with the magnetic shunt 4 in a shunting position;

FIG. 10 is a schematic radial cross-section showing part of the rotor 51 and stator 55 of the related art machine, showing the magnetic flux lines 64a and 64b of the rotor magnets 53a and 53b;

FIG. 11 is a circular axial section of the related art machine along dashed line X of FIG. 10, with the magnetic shunt 54 in a shunting position;

FIG. 12 is further circular axial section of the related art machine along line X of FIG. 10, showing computer-modelled illustrations of the magnetic flux lines 64 with the magnetic shunt 54 in non-shunting position; and

FIG. 13 is further circular axial sections of the related art machine along line X of FIG. 10, showing computer-modelled illustrations of the magnetic flux lines 64 and 64c with the magnetic shunt 54 in shunting position.

### DESCRIPTION OF EMBODIMENTS

### First Embodiment

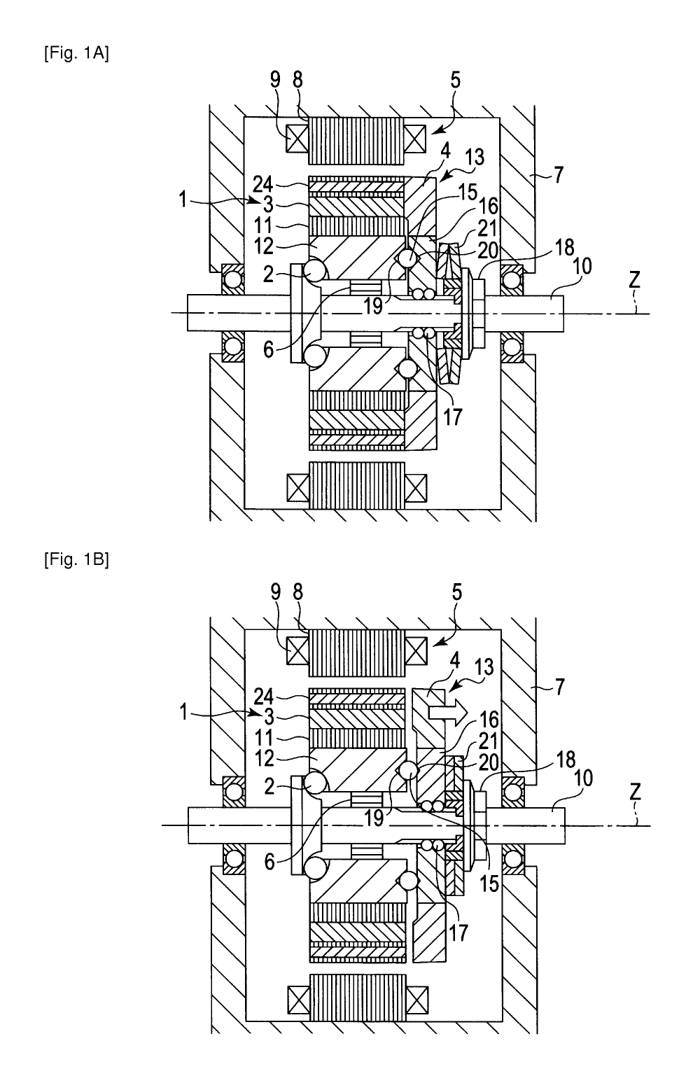

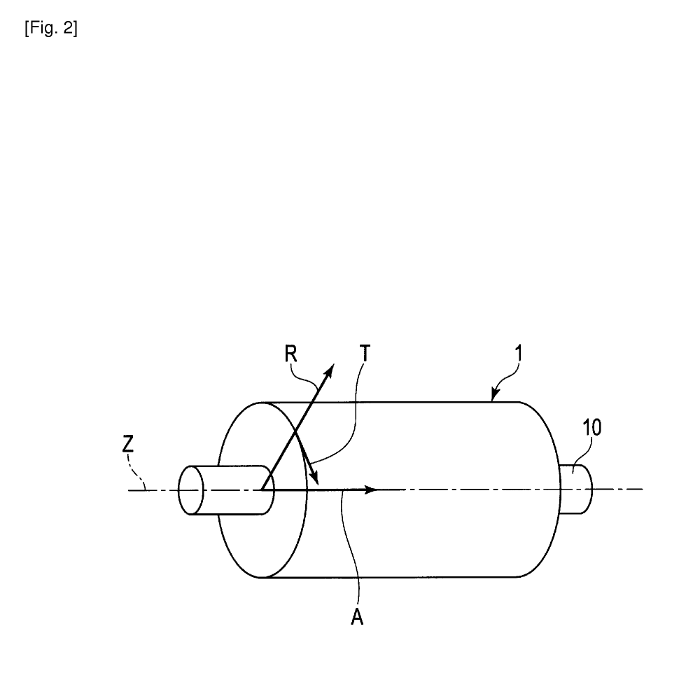

FIG. 1A is a cross-sectional views along the rotating axis of a dynamo-electric machine according to the one ore more embodiments. The dynamo-electric machine includes a rotor 1 mounted by means of an angular bearing 2 and a needle bearing 6 on a shaft 10 on axis Z. The rotor 1 includes a cylindrical electromagnetic rotor core 11 which is supported by an inner rotor body member 12, and a plurality of permanent magnets 3 and a plurality of elongate magnetic core elements (primary magnetically isotropic core elements) 24 which both are mounted in the cylindrical electromagnetic rotor core 11 respectively. The rotor core 11 is made of laminated steel sheets that extend substantially perpendicular to the axis Z and serve to reduce energy losses by hysteresis and eddy currents. As the rotor core 11 is laminated only in the axial direction (as if it were a stack of compact discs), it has anisotropic magnetic properties and encourages the magnetic field of the permanent magnets 3 to flow in the tangential direction (T, shown in FIG. 2) and the radial direction (R, shown in FIG. 2), but not in the axial direction (A, shown in FIG. 2) of the rotor 1. The plurality of permanent magnets 3 and the plurality of elongate magnetic core elements 24 extend through the rotor core 11, substantially parallel to the axis Z respectively.

An annular stator 5 surrounds the rotor 1 with a small radial air gap being provided between the outer surface of the rotor 1 and the inner surface of the stator 5. The stator 5 has stator cores 8 and a plurality of stator coils 9 wound onto the stator cores 8. The stator cores 8 are mounted in a case 7 that forms a housing of the dynamo-electric machine. By supplying electrical current sequentially to the coils 9, a rotating magnetic field can be generated within the annular stator 5, which causes the rotor 1 to rotate by sequentially attracting and repelling the permanent magnets 3.

A magnetic shunt assembly 13 is mounted on the shaft 10 adjacent to one end of the rotor 1. The shunt assembly 13 comprises a magnetic shunt 4 in the form of an annular iron ring or yoke, and a cam plate 16 that is mounted via ball splines 17 on the shaft 10 for axial movement towards or away from the rotor 1. The cam plate 16 is urged towards the adjacent face of the rotor body member 12 by a disc spring 21 that is compressed between the cam plate 16 and a nut 18 on the shaft 10. The cam plate 16 is rigidly connected to the magnetic shunt 4 so that the cam plate 16 and the magnetic shunt 4 move together, both rotationally and longitudinally. Alternatively, the cam plate 16 and the magnetic shunt 4 may comprise a single, integrated component.

A shunt drive mechanism is provided for controlling axial movement of the shunt assembly 13. In this case the shunt drive mechanism has a cam mechanism that includes at least one roller 15 located in ramped grooves 19, 20 in opposed end faces of the rotor body member 12 and the cam plate 16. It should be noted that the rotor 1 is rotatably mounted on the shaft 10 via the angular bearing 2 and the needle bearing 6. Torque is transmitted from the rotor 1 to the shaft 10 through the roller 15, the cam plate 16 and the ball splines 17.

It will be appreciated that although the cam mechanism is shown using a roller, one or more balls may be used instead of the roller, as may be suitable to the application. The working of the shunt drive mechanism will be described below with referring FIGS. 1A and 1B.

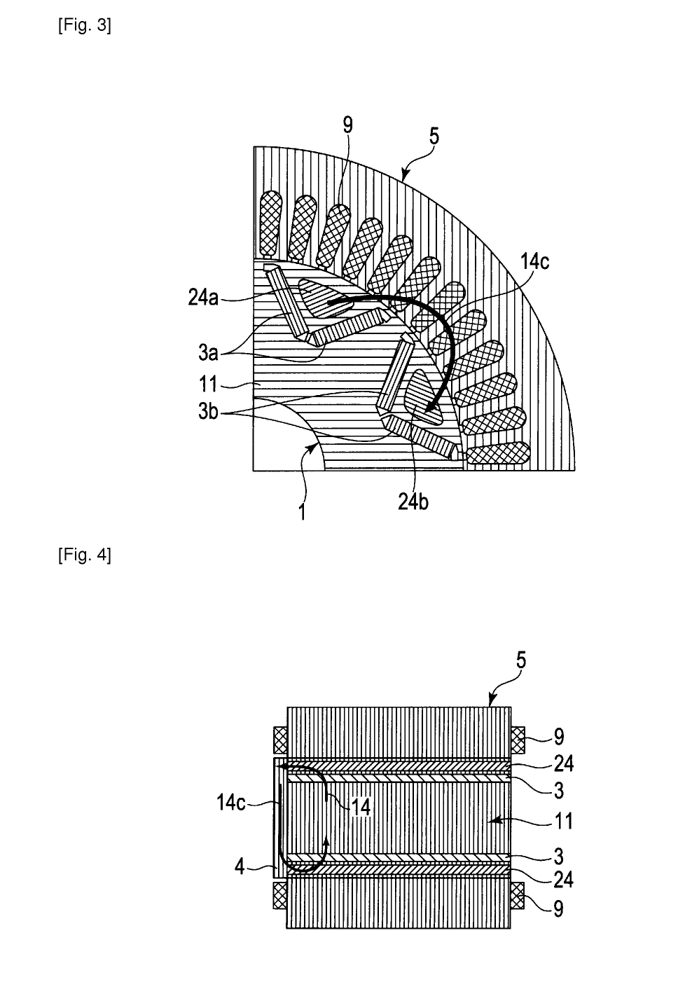

The arrangement of the rotor magnets 3 and the stator coils 9 in the embodiment is illustrated in more detail in FIG. 3. The rotor 1 includes a plurality of planar permanent magnets 3a and 3b. The poles of the permanent magnets 3a and 3b are located on their radially outer and inner faces. The permanent magnets 3a and 3b extend axially along the length of the rotor 1 and are arranged in matched pairs, both permanent magnets of each pair 3a, 3b having the same polarity and each pair of permanent magnets having an opposite polarity to the adjacent pairs 3a and 3b. The two magnets of each pair 3a and 3b are inclined towards each other in a V-shaped formation. The first pair of magnets 3a have their South (S) poles facing outwards and their North (N) poles facing inwards relative to the axis Z of the rotor 1, whereas the second pair of magnets 3b have their North (N) poles facing outwards and their South (S) poles facing inwards.

In this embodiment, rotor 1 includes—in addition to the permanent magnets 3 and the laminated rotor core 11—a plurality of elongate magnetic core elements 24 shown in FIG. 1A that extend through the rotor core 11, substantially parallel to the rotor axis Z. As shown in FIG. 3, one core element 24 is associated with each pair of magnets 3. The core element 24 is located within the V-shaped gap between the outer faces of the permanent magnets 3 and the outer cylindrical surface of the rotor core 11. Hence, the core elements 24 may be surrounded at least partly on at least two sides by permanent magnets 3; which may be arranged in a vee-formation. Thus, as illustrated in FIG. 3, a first core element 24a is associated with the first pair of magnets 3a and a second core element 24b is associated with the second pair of magnets 3b. The core elements 24a and 24b are located radially outward of the permanent magnets 3a and 3b.

The core elements 24 are made of a magnetically isotropic material that conducts the magnetic flux equally in all directions, but which is preferably electrically non-conductive, as an electrically conductive material would encourage eddy current losses. For example, the core elements 24 may be made of a soft magnetic composite (SMC) material comprising insulated iron powder particles. The isotropic core elements 24 therefore serve to reduce the overall magnetic reluctance of the rotor core 11 in the axial direction without significantly increasing eddy current losses.

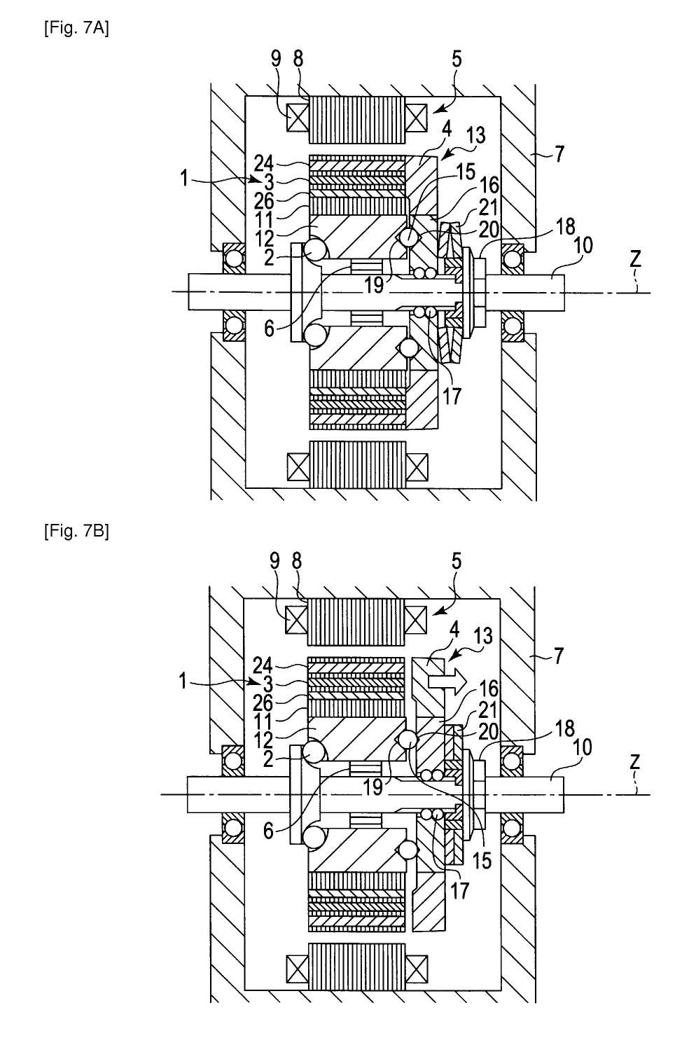

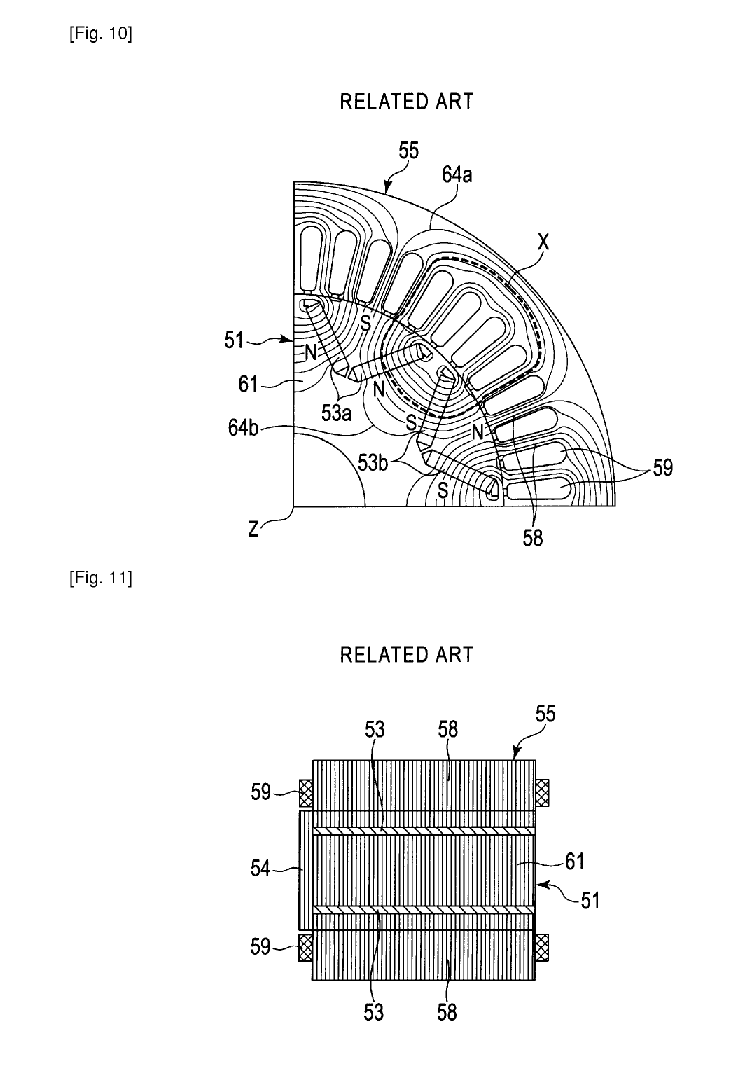

The effect of the isotropic core elements 24 is illustrated in FIGS. 4, 5 and 6. FIGS. 4, 5 and 6 are circular axial sectional views of the dynamo-electric machine of FIG. 3. It should be noted that the “circular” axial sectional views of FIGS. 4-6, FIGS. 9, and 11-13 could also be called “developed” sections. These views present views of the rotor 1 and stator 5 as if it were cut through along the dashed line X in FIG. 10, and then flattened out. Hence, axis Z of the shaft 10 of FIGS. 1A, 1B, 7A and 7B cannot be seen. These views are not easy to visualize in terms of looking at a motor and its components, but are invaluable in terms of understanding the flow of magnetic fields. The top and bottom of each of these Figures are adjacent (rather than opposed) on the actual components.

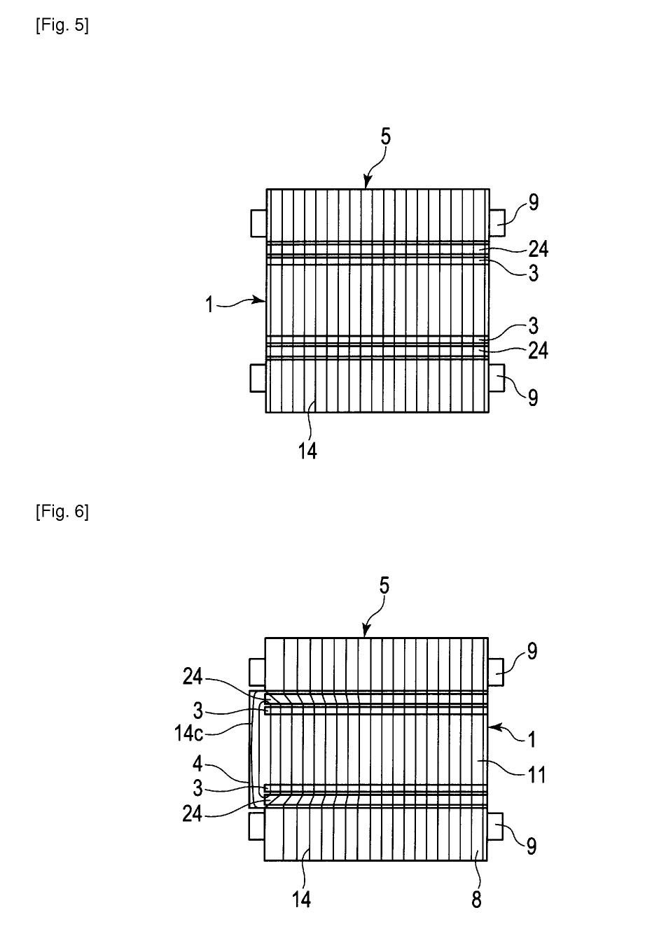

When the magnetic shunt 4 is removed from the end of the rotor core 11 to a non-shunting position, as shown in FIG. 5, the isotropic core elements 24 do not significantly affect the magnetic flux 14 of the permanent magnets 3; as in the absence of the magnetic shunt 4, there is virtually no magnetic flux flowing in the axial direction of the rotor 1.

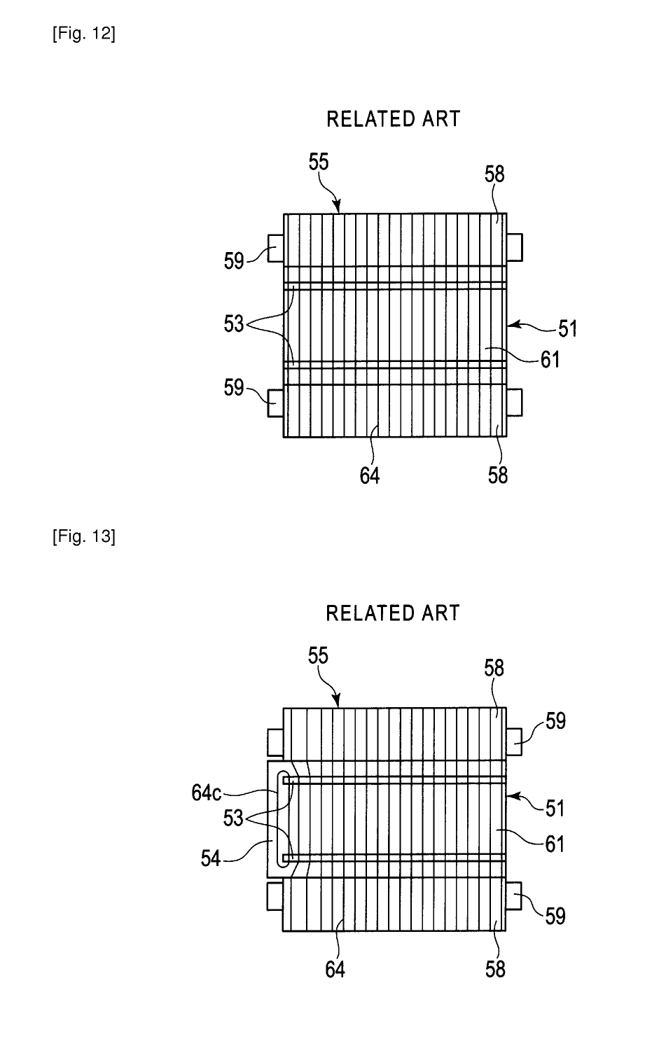

When the magnetic shunt 4 is located against the isotropic core elements 24 appeared at the end of the rotor 1, as shown in FIGS. 4 and 6, the isotropic core elements 24 help to create a magnetic flux circuit 14c that passes through the magnetic shunt 4 and extends through the core elements 24 further into the length of the rotor core 11 in the axial direction than in the related art machine whose shunted magnetic flux circuit is shown in FIG. 13. Within the rotor 1, the magnetic flux 14 flows in the axial direction within the isotropic core elements 24 and in the tangential direction within the laminated core 11. In the ring-shaped magnetic shunt 4, the magnetic flux 14c flows mainly in the tangential direction between adjacent the permanent magnets 3. The isotropic core elements 24 thus help to short-circuit the magnetic flux between adjacent permanent magnets 3, and thus to reduce the flux linkage with the stator coils 9. In this configuration, the applicant has calculated that the flux linkage with the stator coils 9 is reduced by 6.7% as compared to the situation when the magnetic shunt 4 is in a non-shunting condition, as illustrated in FIG. 5. Therefore, the flux leakage is about 6.7%. This represents a 44% increase in flux leakage as compared to the value of 4.7% achieved with the related art machine illustrated in FIGS. 12 and 13.

As explained above, the magnetic flux of permanent magnets 3 is split into two paths which have a primary path linking with the stator coils 9 and a short-circuit path passes through the magnetic shunt 4 and extends through the core elements 24. By controlling the amount of the split flux, the motor characteristics can be altered. The flux is controlled by changing the air gap between the end of the rotor 1 and magnetic shunt 4 depending on the motor torque.

Next, the working of the shunt drive mechanism will be described with referring FIGS. 1A and 1B. The depth of the ramped groove 20 (the depth from the surface of the cam plate 16 facing the inner rotor body member 12) holding the roller 15 with pressure is not uniform but varies throughout the circumferential direction. In other words, when viewing the cross-section of the ramped groove 20 in the circumferential direction, deep wave shapes and shallow wave shapes are formed alternately. FIG. 1A shows the deep wave shapes of the ramped groove 20, FIG. 1B show the shallow wave shapes of the ramped groove 20.

In this case, when the rotor torque is applied to the roller 15 held with pressure between the ramped grooves 19 and 20, the rotor 1 rotates relative to the shunt assembly 13, and the roller 15 moves along the wave shapes according to the level of the rotor torque, so as to change the distances between the ramped grooves 19 and 20. Accordingly, the axial position of the cam plate 16 varies as viewed from the rotor 1.

Then, the roller 15 provides thrust to the cam plate 16 according to the level of the torque transmitted to the roller 15, so as to cause the cam plate 16 to move apart from the rotor 1. On the other hand, the disc spring 21 biases the cam plate 16 to approach the rotor 1.

Therefore, when the rotor torque transmitted to the roller 15 is large, the bias force of the disc spring 21 becomes smaller than the thrust, so that the disc spring 21 is elastically deformed while being pushed toward the rotor axis direction Z. As shown in FIG. 1B, the magnetic shunt 4 is thus separated from the end of the rotor core 11. In other word, at high torque values the rotor 1 rotates relative to the shunt assembly 13 and the movement of the roller 15 within the ramped grooves 19, 20 drives the shunt assembly 13 axially away from the rotor 1, so that there is a gap between the magnetic shunt 4 and the end face of the rotor magnets 3 and the elongate magnetic core elements 24. In this non-shunting position, the magnetic shunt 4 does not significantly affect the magnetic field generated by the rotor magnets 3. As a result, the flux between the permanent magnets 3 is not short-circuited.

On the other hand, when the rotor torque transmitted to the roller 15 is small, the bias force of the disc spring 21 becomes larger than the thrust, so that the magnetic shunt 4 maintains the condition in contact with the rotor core 11. At low torque values, the shunt assembly 13 is pressed by the spring 21 against the end face of the rotor 1, as shown in FIG. 1A. In this shunting position, the magnetic shunt 4 partially short-circuits the permanent magnets 3, so that the magnetic flux 14 flows partially through the magnetic shunt 4. This reduces the magnetic flux linkage between the rotor 1 and the stator 5, and thus reduces the back EMF induced in the stator coils 9 by rotation of the rotor magnets 3, allowing the rotor 1 to rotate at a higher speed and to deliver more power.

As explained above, the shunt drive mechanism is automatically operated and is driven by motor torque output. The shunt drive mechanism controls a axial movement of the magnetic shunt 4 such that the magnetic shunt 4 is displaceable between the shunting position shown in FIG. 1A and the non-shunting position shown in FIG. 1B.

### Effectiveness of the First Embodiment

The dynamo-electric machine can run faster and therefore generate more power if the magnetic flux of the permanent magnets of the rotor is small, as this reduces the induced back EMF. On the other hand, the dynamo-electric machine can generate more torque if the magnetic flux of the permanent magnets of the rotor is large. Various systems have been proposed for modifying the flux linkage between the permanent magnets and the stator coils in order to deliver high torque at low speeds and high power at high speeds, by altering the physical or electrical layout of the stator or the rotor.

Among the various systems, Japanese Patent Application Laid-Open Publication No 2007-244023A describes a permanent magnet dynamo-electric machine having a rotor that carries a set of permanent magnets and a magnetic shunt (or “short-circuit ring”) that is mounted on the shaft of the rotor for axial movement towards and away from one end of the rotor.

The present inventor has found that in the dynamo-electric machine described in JP2007-244023A, although the magnetic shunt causes flux leakage and thus reduces the flux linkage between the permanent magnets and the stator coil, it is only reduced by about 5%. Therefore, although the magnetic shunt increases the power of the machine at high revolution speeds, the increase is quite small.

According to the first embodiment, there is provided a dynamo-electric machine including a stator 5 having a plurality of stator coils 9; a rotor 1 surrounded by the stator 5, having a magnetically anisotropic rotor core 11, a plurality of permanent magnets 3 and at least one magnetically isotropic core element 24; a magnetic shunt 4 configured to shunt the magnetic flux of the at least one of the permanent magnets; and a shunt drive mechanism configured to locate the magnetic shunt 4 against the magnetically isotropic core elements 24.

The magnetically isotropic core element 24 increases flux leakage through the magnetic shunt 4 when the magnetic shunt 4 is located against the magnetically isotropic core elements 24, thereby reducing the back EMF, loss of power generated by the dynamo-electric machine, and load applied to devices which supply current to the dynamo-electric machine at high rotational speeds.

In an example, the magnetically anisotropic rotor core 11 comprises a plurality of laminations that extend substantially perpendicular to a axis Z of the rotor 1, and at least one magnetically isotropic core element 24 extends substantially parallel to the axis Z. The magnetically isotropic core elements 24 then assist the flow of magnetic flux in the axial direction of the rotor 1 when the magnetic shunt 4 is in the shunting position. The laminations extending substantially perpendicular to the axis Z may be substantially circular.

In an example, the plurality of permanent magnets 3 form a plurality of groups 3a, 3b of matched permanent magnets and the at least one magnetically isotropic core element 24 is associated with each group 3a, 3b of permanent magnets. The magnetically isotropic core element 24 assists the leakage of flux into the magnetic shunt 4 for the associated group 3a, 3b of permanent magnets.

In an example, each group 3a, 3b of permanent magnets includes at least two permanent magnets that are arranged in a V-formation with regard to a cross-section of the rotor 1 across the axis Z. The V-shaped formation helps to increase flux linkage with the stator 5.

In an example, the at least one magnetically isotropic core element comprises one or more primary magnetically isotropic core elements 24 that are located radially outward of the permanent magnets 3. The primary magnetically isotropic core elements 24 help to short-circuit the magnetic flux between adjacent permanent magnets 3, and to reduce the flux linkage with the stator coils 9.

In an example, the shunt drive mechanism for controlling axial movement of the magnetic shunt 4 comprises a roller and cam drive mechanism. In an alternative example, the shunt drive mechanism for controlling axial movement of the magnetic shunt 4 comprises a ball and cam drive mechanism.

### Second Embodiment

A dynamo-electric machine according to a second embodiment is illustrated in FIGS. 7A, 7B, 8 and 9. The dynamo-electric machine is similar to the first embodiment shown in FIGS. 1A, 1B, 3 and 4, and the previous description applies equally to the second embodiment, except where indicated otherwise.

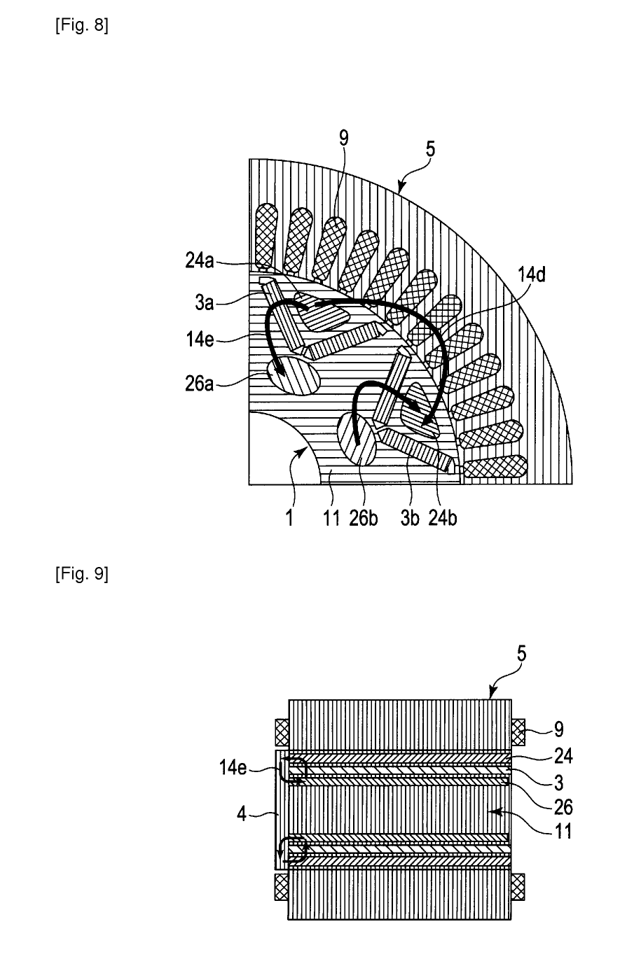

The rotor 1 includes, in addition to the permanent magnets 3, the laminated rotor core 11 and the set of primary elongate magnetic core elements (primary magnetically isotropic core elements) 24, a set of secondary elongate magnetic core elements (secondary magnetically isotropic core elements) 26 that extend through the rotor core 11 substantially parallel to the axis of the rotor 1. One secondary core element 26 is associated with each pair of magnets 3. Each secondary core element 26 is located between the inner faces of the permanent magnets 3 and the inner cylindrical surface of the rotor core 11. Thus, as illustrated in FIG. 8, a secondary core element 26a is associated with the pair of permanent magnets 3a and a secondary core element 26b is associated with the pair of permanent magnets 3b. The secondary core elements 26 are located radially inward of the permanent magnets 3.

The primary and secondary core elements 24, 26 are both made of a magnetically isotropic material that conducts the magnetic flux equally in all directions, but which is preferably electrically non-conductive. For example, the primary and secondary core elements 24, 26 may be made of a soft magnetic composite (SMC) material comprising insulated iron powder particles. The primary and secondary core elements 24, 26 therefore serve to reduce the overall magnetic reluctance of the rotor core 11 in the axial direction without significantly increasing eddy current losses.

The effect of the primary and secondary magnetic core elements 24, 26 is illustrated by the magnetic flux lines 14 shown in FIGS. 8 and 9. When the magnetic shunt 4 is located against the primary and secondary core elements 24, 26 appeared at the end of the rotor 1, as shown in FIG. 9, the primary and secondary core elements 24, 26 create a magnetic flux circuit that passes through the primary and secondary core elements 24, 26 and the magnetic shunt 4 and extends even further into the length of the rotor core 11 in the axial direction than in the first embodiment shown in FIGS. 3 to 6. In particular, as illustrated in FIG. 8, the magnetic flux within the magnetic shunt 4 includes a first component 14d that passes tangentially between adjacent primary core elements 24a, 24b and a second component 14e that passes radially between the paired primary and secondary core elements 24a, 26a, and between the paired primary and secondary core elements 24b, 26b, respectively. The core elements 24, 26 thus help further to short-circuit the magnetic flux between adjacent permanent magnets 3a and 3b and thus further to reduce the flux linkage with the stator coils 9. They also help each permanent magnet 3a and 3b to short-circuit flux within itself, from one pole to the other, in addition to assisting flux leakage between adjacent magnets 3a, 3b.

When the magnetic shunt 4 is removed from the end of the rotor core 11, the primary and secondary core elements 24, 26 do not significantly affect the magnetic flux of the permanent magnets 3, as in the absence of the magnetic shunt 4 there is virtually no magnetic flux flowing in the axial direction of the rotor 1.

According to second embodiment, in addition to the effectiveness described in the first embodiment, the effectiveness as following is achieved. The rotor 1 includes one or more secondary magnetically isotropic core elements 26 that are located radially inwards of the permanent magnets 3. The secondary magnetically isotropic core elements 26 increase flux leakage through the magnetic shunt 4 by encouraging the magnetic flux to flow radially through the magnetic shunt 4. This supplements the tangential flux path through the magnetic shunt 4 that is encouraged by the primary magnetically isotropic core elements 24.

Certain modifications to the various forms of the dynamo-electric machine described in the first and second embodiment are of course possible. For example, although in each of the drawings the isotropic core elements 24, 26 are shown extending through the entire axial length of the rotor 1, the isotropic core elements 24, 26 may be of a shorter length. For example, the isotropic core elements 24, 26 may be provided only at or adjacent one or both ends of the rotor 1. The isotropic core elements 24, 26 may also extend beyond the rotor core 11 at one or both ends of the rotor 1.

### COMPARATIVE EXAMPLE

FIG. 10 is a schematic radial cross-sectional view of part of the rotor 51 and stator 55 according to the comparative example, showing the magnetic flux lines 64a 64b of the permanent magnets 53a and 53b.

As shown in FIG. 10, the outer part 64a of the magnetic field extends radially outwards to increase flux linkage with the stator 55, while the inner part 64b of the magnetic field passes directly between the permanent magnets 53a and 53b through the rotor core 61.

In FIG. 10, the first pair of the permanent magnets 53a have their South (S) poles facing outwards and their North (N) poles facing inwards relative to the axis Z of the rotor 51, whereas the second pair of the permanent magnets 53b have their North (N) poles facing outwards and their South (S) poles facing inwards. As a result, the first and second pairs of permanent magnets 53a and 53b produce a magnetic field having an outer part 64a that extends radially outwards beyond the cylindrical surface of the rotor 51, and an inner part 64b that extends inwards to a far lesser radial extent.

The stator 55 includes a large number of coils 59 that are arranged around the internal face of the stator 55. These coils 59 are energised consecutively to produce a rotating magnetic field within the stator 55, which causes rotation of the rotor 51.

In FIG. 11, the magnetic shunt 54 is shown in a shunting position, in which the magnetic shunt 54 abuts the end of the rotor 51. The magnetic shunt 54 has a low reluctance and therefore when the magnetic shunt 54 is located in the shunting position the magnetic shunt 54 short-circuits the permanent magnets 53, causing flux leakage through the magnetic shunt 54, and thus reducing the flux linkage between the rotor 51 and the stator 55.

The effect of the magnetic shunt 54 is shown more clearly in FIGS. 12 and 13. FIG. 12 illustrates the magnetic flux lines of the magnetic field 64 produced by the permanent magnets 53 when the magnetic shunt 54 (not shown in FIG. 12) is in an inoperative or non-shunting position. This is the situation associated with low speed/high torque output, when the magnetic shunt 54 is separated from the end face of the rotor 51, and therefore does not significantly affect the strength of the magnetic field produced by the permanent magnets 53. The magnetic field lines 64 are perpendicular to the rotational axis of the rotor 51 and are substantially evenly spaced.

FIG. 13 illustrates the magnetic flux lines 64 of the permanent magnets 53 when the magnetic shunt 54 is in a shunting position. This is the situation associated with high speed and low torque output, when the magnetic shunt 54 is in a shunting condition and is pressed against the end face of the rotor 1 in order to short-circuit the permanent magnets 53. Some of the flux lines 64c pass through the magnetic shunt 54 instead of extending outwards into the stator 55. Calculations have shown that the flux linkage with the stator 55 is reduced by 4.7% when the magnetic shunt 54 is in the shunting position, as compared to the situation in which it is in a non-shunting condition as illustrated in FIG. 12. Therefore, the flux leakage through the magnetic shunt 54 is about 4.7%.

Therefore, although the magnetic shunt 54 causes some flux leakage and a corresponding reduction in flux linkage with the stator 55, the flux leakage through the magnetic shunt 54 is relatively small. The applicant believes that this is because the rotor 51 has an anisotropic laminated core 61 whose reluctance is small in the radial and tangential directions, but large in the axial direction. As a result, the magnetic shunt 54 only has a significant effect on the magnetic field in the end region of the rotor core 61 that abuts the magnetic shunt 54. The magnetic field in parts of the rotor 51 that are separated by a greater axial distance from the magnetic shunt 54 is substantially unaffected by the magnetic shunt 54.

The above embodiments exemplify an application of the present invention. Therefore, it is not intended that technical scope of the present invention is limited to the contents disclosed as the embodiments. In other words, the technical scope of the present invention is not limited to the specific technical matters disclosed in the above embodiments and thereby includes modifications, changes, alternative techniques and the like easily lead by the above disclosure.

This application is based on prior British Patent Applications No. GB1016354.1 (filed on Sep. 29, 2010 in England), No. GB1106338.5 (filed on Apr. 14, 2011 in England), No. GB1106526.5 (filed on Apr. 18, 2011 in England), No. GB1106613.1 (filed on Apr. 19, 2011 in England), and No. GB1106723.8 (filed on Apr. 21, 2011 in England). The entire contents of the British Patent Applications No. GB1016354.1, No. GB1106338.5, No. GB1106526.5, No. GB1106613.1, and No. GB1106723.8 from which priority are claimed are incorporated herein by reference, in order to take some protection against omitted portions.

### INDUSTRIAL APPLICABILITY

There is provided a dynamo-electric machine including a stator 5 having a plurality of stator coils 9; a rotor 1 surrounded by the stator 5, having a magnetically anisotropic rotor core 11, a plurality of permanent magnets 3 and at least one magnetically isotropic core element 24; a magnetic shunt 4 configured to shunt the magnetic flux of the at least one of the permanent magnets 3; and a shunt drive mechanism configured to locate the magnetic shunt 4 against the at least one magnetically isotropic core element 24. The magnetically isotropic core elements 24 increase flux leakage through the magnetic shunt 4 when the magnetic shunt 4 is in the shunting position, thereby reducing the back EMF, loss of power generated by the dynamo-electric machine, and load applied to devices which supply current to the dynamo-electric machine at high rotational speeds. Therefore, the dynamo-electric machine according to the present invention is industrially applicable.

### REFERENCE SIGNS LIST

1 Rotor

3 Permanent magnet

4 Magnetic shunt

5 Stator

9 Stator coil

11 Magnetically anisotropic rotor core

24 Primary magnetically isotropic core elements

26 Secondary magnetically isotropic core elements

1-15. (canceled)

16. A dynamo-electric machine, comprising:
a stator having a plurality of stator coils;
a rotor surrounded by the stator, having a magnetically anisotropic rotor core, a plurality of permanent magnets and at least one magnetically isotropic core element;
a magnetic shunt configured to shunt the magnetic flux of the at least one of the permanent magnets; and
a shunt drive mechanism configured to locate the magnetic shunt against the at least one magnetically isotropic core element,
wherein the magnetic shunt is constructed and arranged for axial movement towards and away from one end of the rotor.

17. The dynamo-electric machine according to claim 16, wherein the magnetically anisotropic rotor core comprises a plurality of laminations that extend substantially perpendicular to a axis of the rotor, and at least one magnetically isotropic core element extends substantially parallel to the axis.

18. The dynamo-electric machine according to claim 16, wherein the plurality of permanent magnets form a plurality of groups of matched permanent magnets and the at least one magnetically isotropic core element is associated with each group of permanent magnets.

19. The dynamo-electric machine according to claim 18, wherein each group of permanent magnets includes at least two permanent magnets that are arranged in a V-formation with regard to a cross-section of the rotor across the axis.

20. The dynamo-electric machine according to claim 19, wherein each magnetically isotropic core element is located within the V-formation of a pair of permanent magnets.

21. The dynamo-electric machine according to claim 16, wherein the at least one magnetically isotropic core element comprises one or more primary magnetically isotropic core elements that are located radially outward of the permanent magnets.

22. The dynamo-electric machine according to claim 21, wherein the at least one magnetically isotropic core element further comprises one or more secondary magnetically isotropic core elements that are located radially inward of the permanent magnets.

23. The dynamo-electric machine according to claim 16, wherein the at least one magnetically isotropic core element is made of a material that is electrically non-conductive.

24. The dynamo-electric machine according to claim 23, wherein the at least one magnetically isotropic core element is made of a soft magnetic compound material.

25. The dynamo-electric machine according to claim 16, wherein the shunt drive mechanism controls the axial movement of the magnetic shunt.

26. The dynamo-electric machine according to claim 25, wherein the shunt drive mechanism comprises a roller and cam drive mechanism.

27. The dynamo-electric machine according to claim 25, wherein the shunt drive mechanism comprises a ball and cam drive mechanism.

28. The dynamo-electric machine according to claim 25, wherein the shunt drive mechanism is automatically operated and is driven by motor torque output.

29. A dynamo-electric machine, comprising:
rotating means for outputting or inputting a rotating power, having a magnetically anisotropic rotor core, a plurality of permanent magnets and at least one magnetically isotropic core element;
fixing means for surrounding the rotating means, having a plurality of stator coils;
magnetic shunting means for shunting the magnetic flux of the at least one of the permanent magnets; and
shunt driving means for locating the magnetic shunting means against the at least one magnetically isotropic core element,
wherein the magnetic shunting means is constructed and arranged for axial movement towards and away from one end of the rotating means.
